(19) United States
(12) Patent Application Publication
(10) Pub. No.: US 2015/0200515 A1
(43) Pub. Date: Jul. 16, 2015

(54) Pin Displacement Assembly

(71) Applicant: Pablo Vadillo, Coral Gables, FL (US)

(72) Inventor: Pablo Vadillo, Coral Gables, FL (US)

(21) Appl. No.: 14/154,880

(22) Filed: Jan. 14, 2014

(51) Int. Cl. H01R 43/26

(52) U.S. Cl. CPC H01R 43/26

(57) ABSTRACT

A pin displacement assembly displaces a pin from a socket. The pin may be broken off from a connection plug and thereby difficult to access from inside a cavity in the socket. The assembly utilizes a lever and fulcrum system to leverage a force used to displace the pin from the cavity. The assembly includes a pin contact member that at least partially positions inside the cavity for facilitated access to the pin. A motion transmission device leverages the force for displacing the pin. The motion transmission device includes an arm. The arm includes an arm lever end and an arm pin end. A hinge positions between the arm lever end and the arm pin end. The hinge alters the direction of the force in the form of torque, by rotating the arm about the hinge. In this manner, the optimal mechanical advantage is realized.

### FIELD OF THE INVENTION

The present invention relates generally to pin displacement from a socket. More so, a pin displacement assembly utilizes a mechanical advantage from a lever and fulcrum, and a pin contact member positioned inside the socket to facilitate displacement of the pin from a socket, even if the pin is separated from a connection plug.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a connection plug is a common family of connector typically used for analog signals, primarily audio. It is cylindrical in shape, typically with two, three or four contacts. A pin having wiring and conductive rings extends from the housing of the connection plug.

It is well known that conventional connection plugs typically comprise a socket, and a plug which is received in the socket. For example, in an airline cabin, an in-flight entertainment system may provide media such as audio and video information to passenger seat locations, so that it is available to passengers.

aviation vehicle connection plugs are similar, but not identical. A standard ¼ in monaural plug, type PJ-055, is used for headphones, paired with special tip-ring-sleeve, 0.206 inch diameter plug, type PJ-068, for the microphone. On the microphone plug a ring is used for the microphone ‘hot’ and the sleeve is common or microphone ‘Lo’.

Often, connection plugs on an aviation vehicle break as the protruding plug housing snags on the clothing of a moving passenger, which causes the pin to break when the cable is stretched to its maximum. Also, it is common for seated passengers to stand up, without removing the headset, thereby resulting in the pin forcibly detaching from the connection plug. Often, the pin remains inside the cavity of the socket without the connection plug to help extract it.

It may be helpful to have a device that quickly and efficiently allows for displacement of the pin from the cavity without disassembling the headphone system and socket.

In view of the foregoing, it is clear that these traditional techniques are not perfect and leave room for more optimal approaches.

### SUMMARY OF THE INVENTION

This invention is directed to a pin displacement assembly that at least partially displaces a pin from a socket, even when a connection plug is detached from the pin. The pin displacement assembly utilizes a lever and fulcrum system to leverage the force used to displace the pin from a cavity in the socket. The pin displacement assembly further includes a pin contact member that at least partially positions inside the cavity for exerting a force that pushes the pin out of a cavity in the socket.

In one embodiment, the pin displacement assembly may include a motion transmission device for leveraging the force to displace the pin from a cavity interior end towards a cavity exterior end. The motion transmission device may be adapted to translate a force into a greater output force. In this manner, the force may be leveraged through a mechanical advantage provided by the motion transmission device. Consequently, the amount of force required for the motion transmission device to push the pin out of a cavity in the socket may be reduced; thereby facilitating pin displacement. Additionally, the pin contact member positions at least partially inside the cavity, and is operable to push the pin from a cavity interior end towards a cavity exterior end during displacement. The internal positioning of the pin contact member provides another advantage because, otherwise, the pin's position inside the cavity may be difficult to access or grip; especially when the pin separates from the connection plug.

In some embodiments, the pin may be separated or broken off from a connection plug, and thereby difficult to access without the connection plug attached. The connection plug may connect to a pair of headphones, such as is provided in a passenger seat on an aviation vehicle. Those skilled in the art will recognize that that the connection plug is generally fragile, and therefore susceptible to forcibly separating from the pin, especially in a passenger seat of an aviation vehicle where a passenger may move abruptly, and thereby break off the connection plug from the socket. Consequently, if the pin forcibly separates from the connection plug, the pin may remain stuck in the cavity until the socket and headphone assembly are disassembled to access the pin for removal. Removing the pin in this manner may be time consuming and labor intensive. The pin displacement assembly provides a solution to remove the pin from the cavity with minimal force and minimal gripping surface.

A first aspect of the present invention provides a pin displacement assembly for at least partially displacing a pin from a socket, the pin displacement assembly comprising:
a socket, the socket comprising a cavity for at least partially receiving a connection plug, the cavity comprising a cavity interior end and a cavity exterior end, the connection plug comprising a pin, the pin being configured to extend from the connection plug, the pin further being configured to at least partially enter the cavity; and
a motion transmission device adapted to transmit a force for at least partially displacing the pin from the cavity interior end towards the cavity exterior end,
the motion transmission device comprising a pin contact member configured to engage the pin during displacement,
the motion transmission device further comprising an arm, the arm comprising an arm pin end adapted to attach to the pin contact member, the arm further comprising an arm lever end, the two ends being generally coplanar and pivotally connected at a hinge,
wherein the force applied to the arm lever end pivotally affects displacement of the arm pin end from the cavity interior end to the cavity exterior end,
the release mechanism further comprising a force initiation point adapted to attach to the arm lever end, the force initiation point being configured to receive the force for affecting the arm lever end.

In a second aspect, the pin comprises a broken pin separated from the connection plug. The broken pin may be difficult to displace from the cavity of the socket without the connection plug to grip.

In another aspect the motion transmission device includes an arm that acts as a simple machine lever for increasing, through mechanical advantage, a force that is transmitted from a force initiation point to a pin contact member that positions at least partially inside the cavity to engage the pin.

In another aspect, the arm includes an arm lever end and an arm pin end. A hinge is adapted to position between the arm lever end and the arm pin end. The hinge alters the direction of the force in the form of torque, by rotating the arm about the hinge. In this manner, the optimal mechanical advantage may be realized for the motion transmission device. Consequently, the amount of force required for the pin contact member to push the pin out of a cavity in the socket may be reduced; thereby facilitating pin displacement.

In another aspect, the force initiation point comprises a button or rod configured to be operable to receive the force from a hand. The force applied by the hand may be generally equal to the force of a hand pushing a button.

In yet another aspect, the socket includes a socket for a headphone system on a passenger seat of an aviation vehicle.

In yet another aspect, the motion transmission device may include a direct push, linear arm, rather than the arm that is hinged, for displacing the pin contact member. The linear arm does not utilize a hinge, and therefore does not receive a mechanical advantage for the force. The linear arm may be disposed to position directly behind the cavity.

In one objective of the present invention, the broken pin, separated from the connection plug may be displaced from the cavity without requiring disassembling of the socket and headphone system. The pin contact member, which positions at least partially inside the cavity, may displace the pin with an externally applied force.

In yet another objective, the cost of replacement or maintenance of the socket and headphone system may be minimized, as only the connection plug and broken pin require replacement.

In yet another objective, the motion transmission device is relatively simple mechanism requiring few parts and can be manufactured relatively inexpensively.

These and other advantages of the invention will be further understood and appreciated by those skilled in the art by reference to the following written specification, claims and appended drawings.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary pin displacement assembly coupled with an exemplary connection plug, in accordance with an embodiment of the present invention;

FIG. 2 illustrates a detailed perspective view of an exemplary pin displacement assembly, with an exemplary force initiation point positioned to displace a pin from a socket, and the pin displaced from the socket, in accordance with an embodiment of the present invention;

FIGS. 3A and 3B illustrate side sectioned views of an exemplary motion transmission device, where FIG. 3A illustrates an exemplary pin inside the cavity, and FIG. 3B illustrates an exemplary arm displacing the pin from the cavity;

FIG. 4 illustrates an elevated side view of an exemplary second embodiment of a pin displacement assembly utilizing an exemplary direct push, linear motion transmission device, in accordance with an embodiment of the present invention;

FIG. 5 illustrates a rear view of an exemplary second embodiment of a pin displacement assembly utilizing an exemplary direct push, linear motion transmission device, in accordance with an embodiment of the present invention;

FIG. 6 illustrates a top view of an exemplary second embodiment of a pin displacement assembly utilizing an exemplary direct push, linear motion transmission device, in accordance with an embodiment of the present invention; and

FIG. 7 illustrates a method for displacing a pin from a socket, in accordance with an embodiment of the present invention.

Like reference numerals refer to like parts throughout the various views of the drawings.

### DETAILED DESCRIPTION OF THE INVENTION

The present invention is best understood by reference to the detailed figures and description set forth herein.

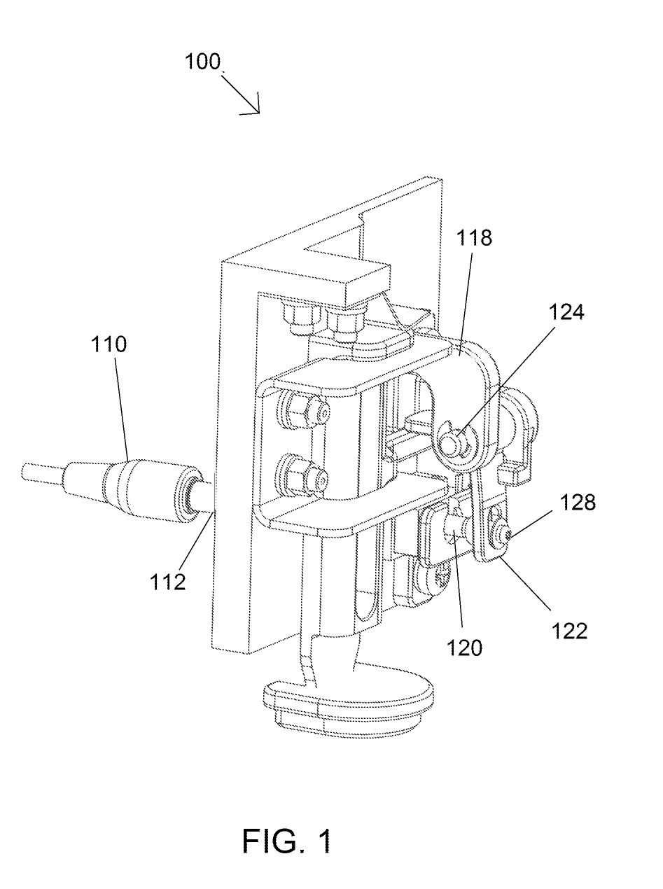

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

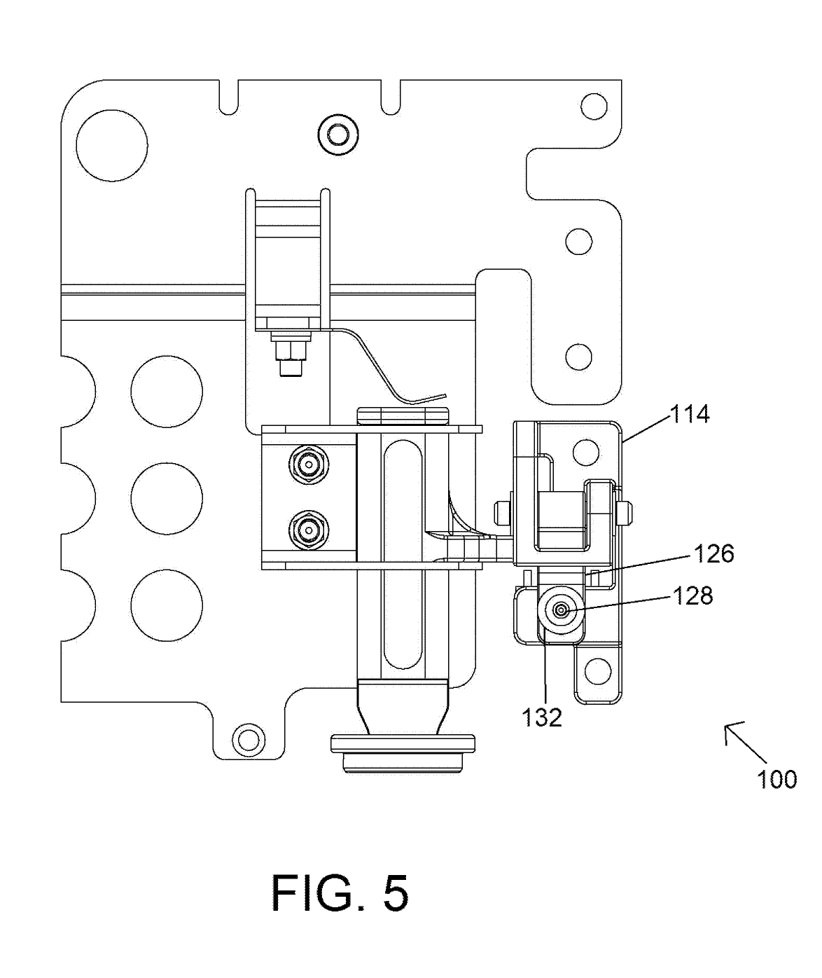

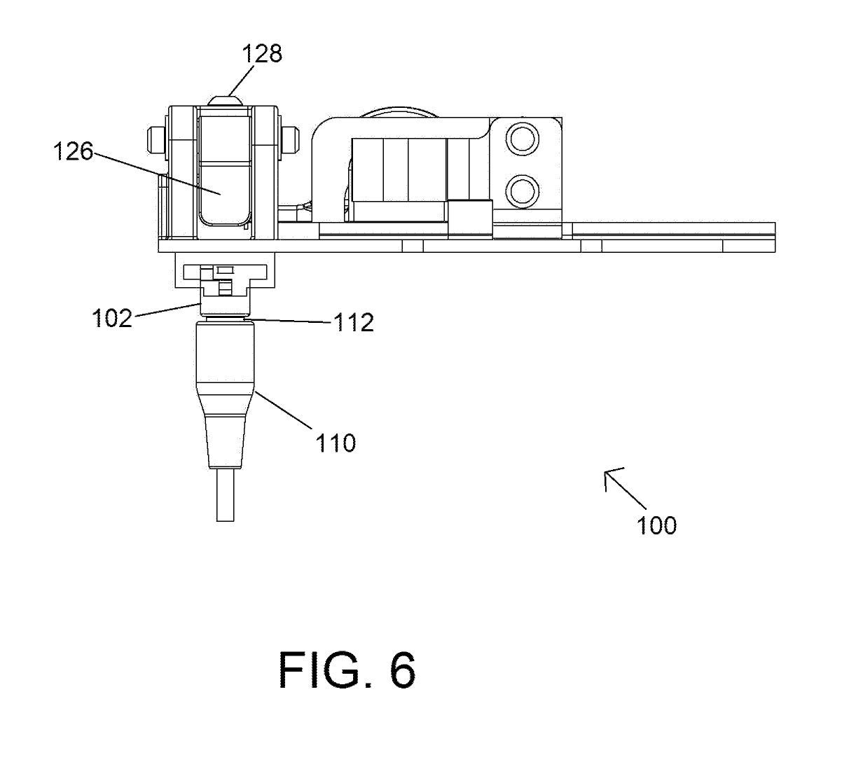

A pin displacement assembly 100 is described in FIGS. 1 through 7.

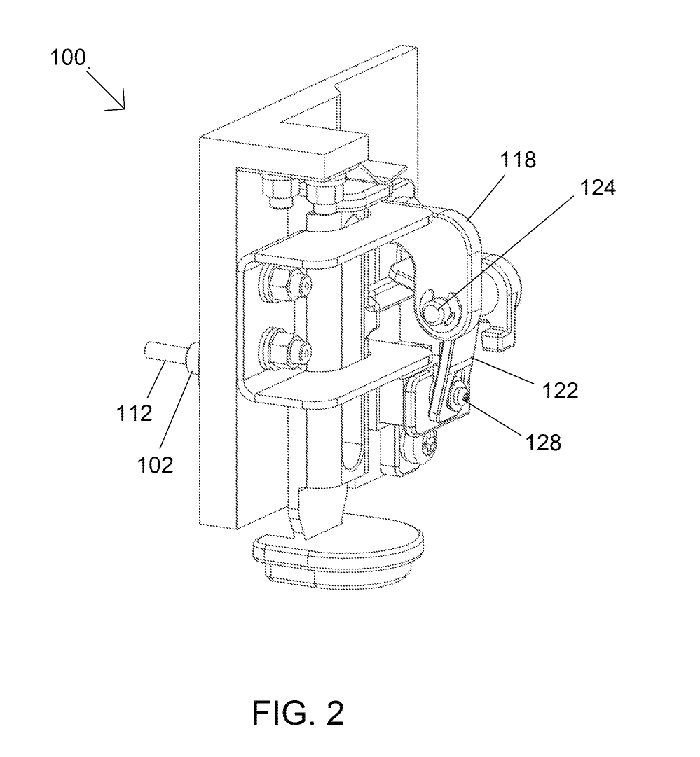

As referenced in FIGS. 1 and 2, the pin displacement assembly 100 is configured to at least partially displace a pin 112 from a socket 102. In some embodiments, the pin 112 may have been forcibly separated from a connection plug 110, and thereby remained lodge in a cavity 104 of the socket 102. In this position, the pin 112 may not provide adequate grip for removal from the cavity 104.

In some embodiments, the pin displacement assembly 100 comprises a socket 102 having a cavity 104 for at least partially receiving the connection plug 110. In one embodiment, the socket 102 may include a headphone system on a passenger seat of an aviation vehicle. However in other embodiments, the socket 102 may include, without limitation, any type of headphone, mobile phone, computer, laptop, tablet, and microphone connection. Suitable materials for the pin displacement assembly 100 may include, without limitation, metal, a metal alloy, a rigid polymer, fiberglass, polyvinyl chloride, wood, and rubber.

Those skilled in the art, in light of the present teachings, will recognize that a passenger on an aviation vehicle may have a tendency to move abruptly or leave the seat without disconnecting the connection plug 110 from the socket 102. This type of movement may cause a forcible detachment that breaks off the pin 112 from the connection plug 110, thereby making the pin 112 inaccessible to remove from a cavity 104 in the socket 102. The pin displacement assembly 100 provides components that not only force the pin 112 out of the cavity 104, through a cavity exterior end 108; but also leverage the force 130 applied to a motion transmission device 114, so that the effort required to displace the pin is minimized. This minimal requirement for the force 130 may be useful when an electrical motor is utilized to apply the force 130, so that power usage is minimized.

In some embodiments, the cavity 104 comprises a cavity interior end 106 and a cavity exterior end 108. The pin 112 may be at least partially lodges between each end. The pin 112 may include a diameter equal to, or smaller than the cavity 104. This similar diameter creates difficulty for extracting the pin 112 from the cavity 104 without having the larger surface area of an attached connection plug 110. The pin 112 may include wiring and conductive rings for enabling an audio signal and microphone power. However, when the pin 112 detaches from the connection plug 110, the pin 112 may be difficult to grip from inside the cavity 104.

In some embodiments, the pin displacement assembly 100 comprises a motion transmission device 114 adapted to at least partially transmit the force 130 for displacing the pin 112 from the cavity interior end 106 towards the cavity exterior end 108. The motion transmission device 114 may utilize a mechanical advantage of a lever and a fulcrum to facilitate the effort required to displace the pin 112 from the cavity 104. In this invention, the lever is an arm 118, and the fulcrum is a hinge 124. However, in other embodiments, the motion transmission device 114 may include a linear arm 126 that simply pushes the pin 112 out of the cavity 104 in direct relation to the applied force 130.

As reference in FIG. 2, the motion transmission device 114 may include a pin contact member 116 configured to engage the pin 112 during displacement. The pin contact member 116 is sized and dimensioned to traverse along a longitudinal axis of the cavity 104, and engage the pin 112. The pin contact member 116 may include a rod that positions inside the cavity 104, and is operable to push the pin 112 through a cavity interior end 106 towards a cavity exterior end 108 during displacement. The internal position of the pin contact member 116 enables removal of the pin 112 from the cavity 104. Without the internally localized position of the pin contact member 116, the pin's 112 position inside the cavity 104 may be difficult to access or grip, especially when the pin 112 separates from the connection plug 110.

The motion transmission device 114 further comprises an arm 118. The arm 118 includes an arm pin end 120 that is adapted to attach to the pin contact member 116. The arm 118 further includes an arm lever end 122 adapted to receive the force 130 at a force initiation point 128. The force initiation point 128 may include a button that attaches to the arm lever end 122. However in other embodiments, the force initiation point 128 may include, without limitation, a rod, a string, a pulley, and a sensor with a motor. The force 130 exerted on the force initiation point 128 creates sufficient thrust to displace the pin 112 from the cavity 104. In one embodiment, the force 130 may include a hand or finger that pushes on the force initiation point 128 with sufficient effort to displace the pin 112 form the cavity 104. However in other embodiments, the force 130 may be generated automatically through an electric motor.

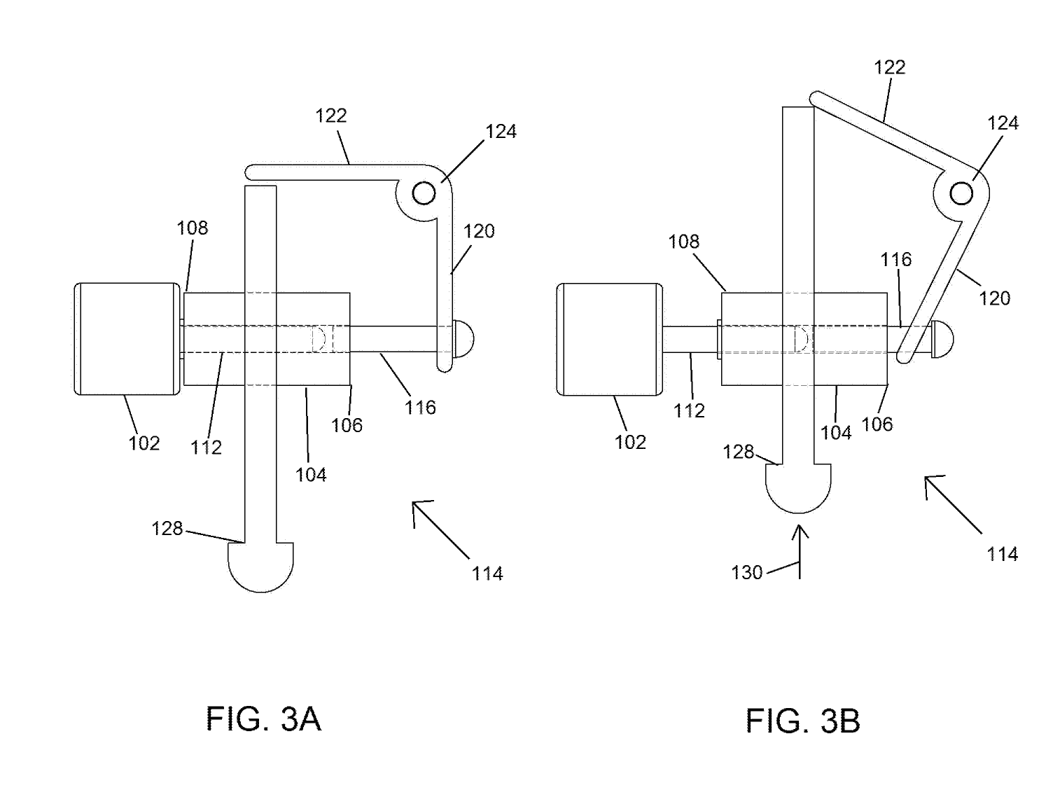

Turning now to FIGS. 3A and 3B, the arm 118 includes a hinge 124 adapted to position between an arm lever end 122 and an arm pin end 120. The hinge 124 serves as a fulcrum that enables each end to pivot relative to each other for creating a mechanical advantage. The arm pin end 120 and the arm lever end 122 are generally coplanar and pivotally connected at a hinge 124. In some embodiments, the length of the arm pin end 120 is about equal to the length of the arm lever end 122.

In one embodiment, the force initiation point 128 receives the force 130 from an object, such as a hand or finger, and transfers the force 130 to the arm lever end 122. The force 130 exerted on the arm lever end 122 pivotally affects displacement of the arm pin end 120. The hinge 124 alters the direction of the force 130 in the form of torque, by rotating the arm 118 about the hinge 124. In this manner, the optimal mechanical advantage may be realized for the motion transmission device 114. Consequently, the amount of force 130 required for the pin contact member 116 to push the pin 112 out of the cavity 104 may be reduced, thereby facilitating displacement of the pin 112.

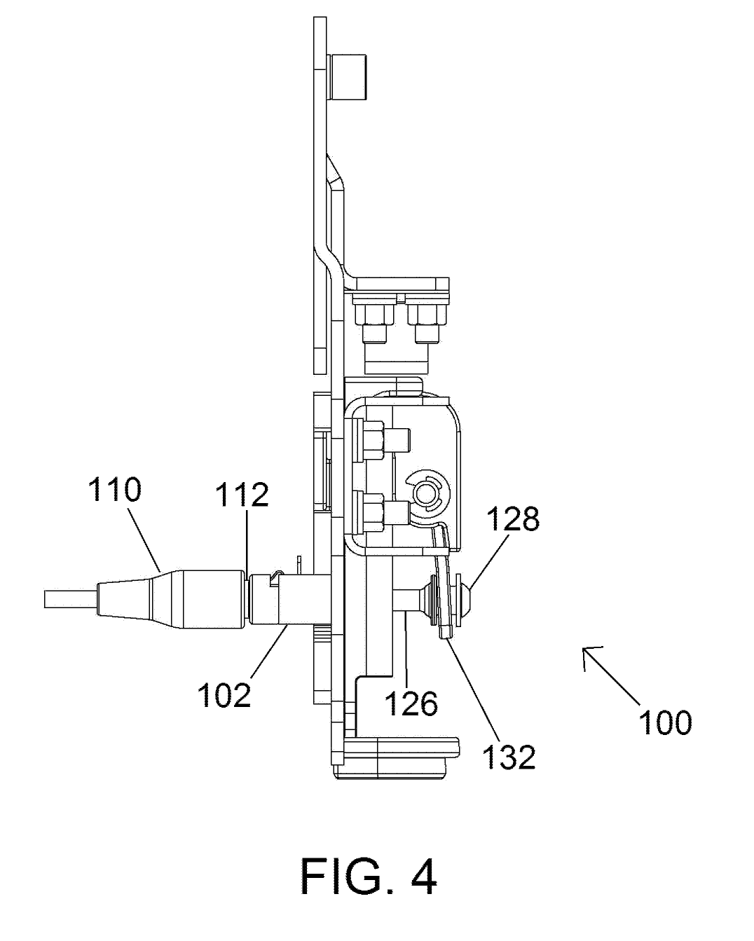

In one embodiment of the present invention, the motion transmission device 114 may include a linear arm 126 having no hinge 124 and a unitary rod shape. FIGS. 4, 5, and 6 illustrate various views of the pin displacement assembly 100 with the linear arm 126 positioned directly behind the cavity 104, and a force initiation point 128 in the form of a button for exerting the force 130 on the linear arm 126. The linear arm 126 may include a guide portion 132, such as a washer, to provide support and align the linear arm 126 with the cavity 104. The guide portion 132 fastens to the motion transmission device and remains stationary.

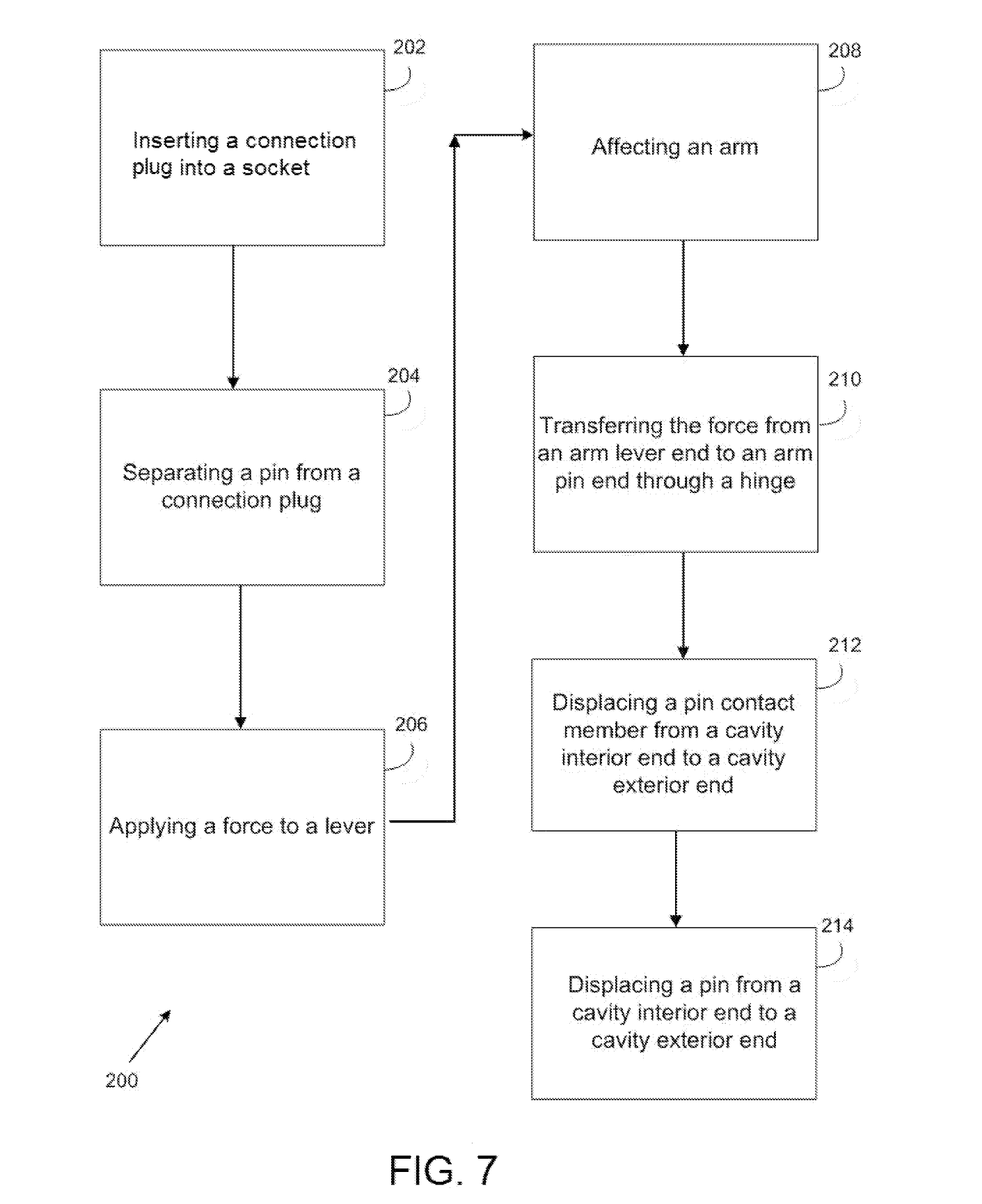

FIG. 7 illustrates a method 200 for displacing a pin 112 from a socket 102. The method 200 facilitates displacement of the pin 112 from a cavity 104 in the socket 102. A motion transmission device 114 leverages the force 130 applied, and transmits the force 130 to a pin contact member 116 that engages and pushes the pin 112 through the cavity 104. The method may include an initial Step 202 of inserting a connection plug 110 into a socket 102. The connection plug 110 may be utilized in a headphone system for a passenger seat of an aviation vehicle. However, the connection plug 110 from myriad electrical components could also utilize the present invention.

A next Step 204 may include separating a pin 112 from the connection plug 110. In one embodiment, a sudden or excessively forceful movement may cause a detachment that breaks off the pin 112 from the connection plug 110, thereby making the pin 112 inaccessible to remove from a cavity 104 in the socket 102. The pin displacement assembly 100 provides components that not only displace the pin 112 out of the cavity 104, through an exterior cavity 104 end; but also leverage the force 130 applied to a motion transmission device 114, so that the effort is minimized.

The method 200 may include a Step 206 of applying a force 130 to a force initiation point 128. The force initiation point 128 may include a button that attaches to the arm lever end 122. However in other embodiments, the force initiation point 128 may include, without limitation, a rod, a string, a pulley, and a sensor with a motor. The force 130 exerted on the force initiation point 128 creates sufficient thrust to displace the pin 112 from the cavity 104. A Step 208 comprises affecting an arm 118. The arm 118 forms the chief component of the motion transmission device 114. The motion transmission device 114 may be adapted to translate the force 130 applied to the arm 118. Since the arm 118 utilizes principles of levers and fulcrums, the force 130 may be translated a greater output force 130. In this manner, the force 130 may be leveraged through a mechanical advantage provided by the arm 118. Consequently, the amount of force 130 required for the motion transmission device 114 to push the pin 112 out of a cavity 104 in the socket 102 may be reduced; thereby facilitating displacement of the pin 112.

In some embodiments, a Step 210 includes transmitting the force 130 from an arm lever end 122 to an arm pin end 120 through a hinge 124. The arm 118 includes a hinge 124 adapted to position between the arm lever end 122 and the arm pin end 120. The hinge 124 serves as a fulcrum that enables the arm lever end 122 and the arm pin end 120 to pivot relative to each other for creating a mechanical advantage. The resultant force 130 is greater and transmits to the arm pin end 120, and finally to the connected pin contact member 116.

Step 212 may include displacing a pin contact member 116 from a cavity interior end 106 to a cavity exterior end 108. The pin contact member 116 receives the force 130 and moves along a longitudinal; axis of the cavity 104 while engaging the pin 112. A final Step 214 includes displacing the pin 112 from the cavity interior end 106 to the cavity exterior end 108. The pin 112 is displaced from the cavity 104, from the cavity interior end to the cavity exterior end 108, by the force 130 exerted on the pin contact member 116. In this manner, the pin 112 is displaced from the cavity 104 even if gripping the pin 112 externally from the cavity 104 is difficult. Also, a lesser force may be utilized to displace the pin 112.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. A pin displacement assembly for at least partially displacing a pin from a socket, the pin displacement assembly comprising:
a socket, the socket comprising a cavity for at least partially receiving a connection plug, the cavity comprising a cavity interior end and a cavity exterior end, the connection plug comprising a pin, the pin being configured to extend from the connection plug, the pin further being configured to at least partially enter the cavity; and
a motion transmission device adapted to transmit a force for at least partially displacing the pin from the cavity interior end towards the cavity exterior end,
the motion transmission device comprising a pin contact member configured to engage the pin during displacement,
the motion transmission device further comprising an arm, the arm comprising an arm pin end adapted to attach to the pin contact member, the arm further comprising an arm lever end, the two ends being generally coplanar and pivotally connected at a hinge,
wherein the force applied to the arm force lever end pivotally affects displacement of the arm pin end from the cavity interior end to the cavity exterior end.

2. The assembly of claim 1, in which the pin comprises a broken pin at least partially separated from the connection plug.

3. The assembly of claim 1, in which the connection plug comprises an aviation vehicle headphone plug.

4. The assembly of claim 1, in which the socket is configured for a passenger seat on an aviation vehicle.

5. The assembly of claim 1, in which a pin diameter is equal or less than a cavity diameter.

6. The assembly of claim 1, in which the connection plug comprises a ¼ monaural plug.

7. The assembly of claim 1, in which the pin comprises wiring and rings for enabling an audio signal and microphone power.

8. The assembly of claim 1, in which the force comprises a hand pushing the force initiation point.

9. The assembly of claim 1, in which the arm is adapted to provide a mechanical advantage for the force.

10. The assembly of claim 1, in which the hinge alters the direction of the force in the form of torque.

11. The assembly of claim 1, in which the arm pin end comprises a length about equal with the arm force initiation point end.

12. The assembly of claim 1, in which the hinge comprises a bearing adapted to connect the arm pin end to the arm force initiation point end.

13. The assembly of claim 1, in which the hinge is adapted to allow a limited angle of rotation between the arm pin end and the arm force initiation point end.

14. The assembly of claim 1, in which the release mechanism comprises a force initiation point adapted to attach to the arm lever end, the force initiation point being configured to receive the force for affecting the arm lever end, the force initiation point comprising a button.

15. A pin displacement assembly for linearly displacing a pin from a socket, the pin displacement assembly comprising:
a socket, the socket comprising a cavity for at least partially receiving a connection plug, the cavity comprising a cavity interior end and a cavity exterior end, the connection plug comprising a pin, the pin being configured to extend from the connection plug, the pin further being configured to at least partially enter the cavity; and
a motion transmission device adapted to transmit a force for at least partially displacing the pin from the cavity interior end towards the cavity exterior end,
the motion transmission device comprising a pin contact member configured to engage the pin during displacement,
the motion transmission device further comprising a linear arm,
wherein the force applied to the linear arm transmits to the pin contact member for displacing the pin from the cavity interior end to the cavity exterior end,
the release mechanism further comprising a force initiation point adapted to attach to the linear arm, the force initiation point being configured to receive the force for affecting the linear arm.

16. The assembly of claim 15, in which the linear arm is disposed to position in a proximal area behind the cavity.

17. The assembly of claim 15, in which the pin comprises a broken pin at least partially separated from the connection plug.

18. The assembly of claim 15, in which the connection plug comprises an aviation vehicle headphone plug.

19. The assembly of claim 15, in which the force comprises a hand pushing the force initiation point.

20. A method for at least partially displacing a pin from a socket, the method comprising:
inserting a connection plug into a socket;
separating a pin from the connection plug;
applying a force to a force initiation point;
affecting an arm;
transmitting the force from an arm lever end to an arm pin end through a hinge;
displacing a pin contact member from a cavity interior end to a cavity exterior end; and
displacing the pin from the cavity interior end to the cavity exterior end.
